(19) United States
(12) Patent Application Publication
(10) Pub. No.: US 2026/0023629 A1
(43) Pub. Date: Jan. 22, 2026

(54) SYSTEM AND METHOD FOR REQUESTING SYSTEM SERVICES

(71) Applicant: UNTETHER AI CORPORATION, Toronto (CA)

(72) Inventors: Bart Trojanowski, Ottawa (CA); Dai Qin, Scarborough (CA)

(21) Appl. No.: 18/945,223

(22) Filed: Nov. 12, 2024

Related U.S. Application Data
(60) Provisional application No. 63/672,045, filed on Jul. 16, 2024.

(51) Int. Cl. G06F 9/54

(52) U.S. Cl. CPC G06F 9/547

(57) ABSTRACT

An example host computing device includes: a memory and a communications interface; a processor interconnected with the memory and the communications interface, the processor configured to: detect a request, by a target computing device, for execution of a system service by the host computing device; obtain system service parameters for the requested system service; execute the system service in accordance with the system service parameters; and send a completion indicator to the target computing device.

### FIELD

The specification relates generally to systems and methods for requesting and provisioning system calls, and more particularly to systems and methods for requesting and provisioning system calls in a constrained environment.

### BACKGROUND

Some computing devices operate in constrained environments in which certain basic system services are limited due to the lack of operating system. During execution of programs in such environments, it may be helpful to be able to access such system services, however provisioning such services is constrained by the operating environment.

### SUMMARY

According to an aspect of the present specification an example device includes: a memory and a communications interface; a processor interconnected with the memory and the communications interface, the processor configured to: detect a request, by a target computing device, for execution of a system service by the host computing device; obtain system service parameters for a system service requested by the exception; execute the system service in accordance with the system service parameters; and send a completion indicator to the target computing device.

According to another aspect of the present specification, an example device includes: a plurality of processing elements configured to execute a program; a memory and a communications interface; a controller interconnected with the memory, the communications interface, and the plurality of processing elements, the controller configured to: during execution of the program by at least one of the processing elements, detect a service request condition for requesting a system service from a host device; in response to the service request condition, generate an exception to request the system service from the host device; and in response to a completion indicator indicating completion of the requested system service from the host device, resume execution of the program.

According to another aspect of the present specification, an example method includes: detecting, at a host device, a request for a system service at a target device; obtaining system service parameters for processing the request from the target device; executing the system service request in accordance with the system service parameters; and sending a completion indicator to the target device.

According to another aspect of the present specification, an example method includes: during execution of a program at a target device, detecting a service request condition for requesting a system service from a host device; in response to the service request condition, generating an exception to request the system service from the host device; in response to a completion indicator from the host device, resuming the execution of the program.

### BRIEF DESCRIPTION OF DRAWINGS

Implementations are described with reference to the following figures, in which:

FIG. 1 depicts a schematic diagram of an example system requesting and provisioning system services to a constrained environment.

FIG. 2 depicts a flowchart of an example method of requesting and provisioning system services to a constrained environment.

FIGS. 3A-3D depict schematic diagrams of an example performance of the method of FIG. 2.

### DETAILED DESCRIPTION

Most computing devices include an operating system having a kernel which may be utilized to execute system calls, for example to log data, to read or write files, or the like. These access requests to system services may be generated by applications running on the computing devices. However, some computing devices may operate in a constrained environments, such as a graphical processing unit (GPU) or other specialized chips and may not have access to a self-contained operating system and hence suitable system services.

In accordance with the present disclosure, such target devices (i.e., devices operating in constrained environments) may be in communication with a host computing device to which the target device may issue a host call to leverage the system services of the host computing device.

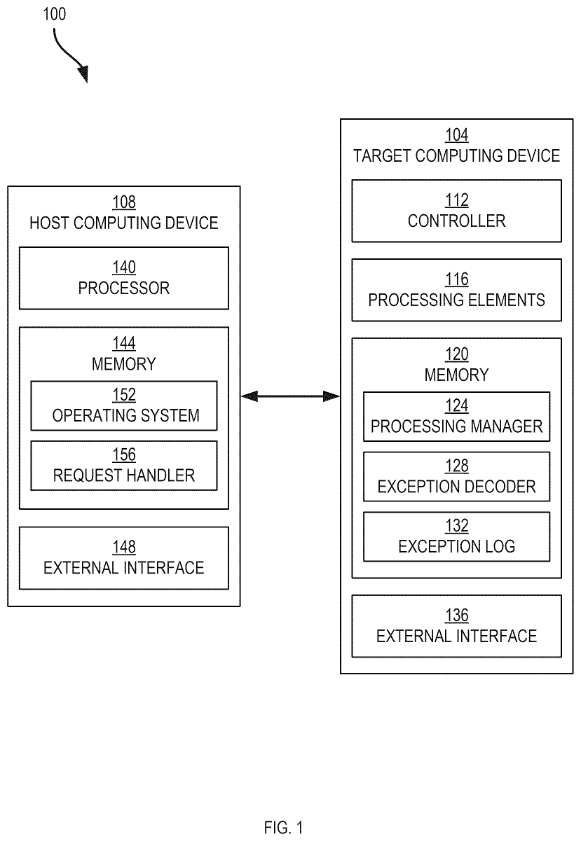

FIG. 1 depicts an example system 100 for requesting system services in accordance with the present disclosure. The system 100 includes a target computing device 104 operating in a constrained environment and a host computing device 108 operating at a regular system capacity.

The target computing device 104 (also referred to herein as simply the target device 104) may be a GPU or other specialized chip. For example, the target device 104 may have a spatial architecture and may be implemented with a configurable arrangement of processing elements and/or a closed set of such arrangements, which may be termed a “compute unit” in that a particular arrangement or closed set thereof performs a particular processing objective. This may provide flexibility for how a particular operation is performed. For example, the target computing device 104 may be deployed to implement operations for a neural network computation, artificial intelligence (AI) programs, large-language models (LLMs), machine vision programs, or similar. For example, the target computing device 104 may be configured to operate according to single instruction multiple data (SIMD) principles within a compute unit. At a high level, the compute units may communicate via a dataflow spatial architecture that is akin to a mesh network.

In the present example, the target computing device 104 includes a controller 112, such as a processor (e.g., microcontroller, etc.) that may be configured to control connected processing elements 116. The target computing device 104 may include any number of processing elements 116, arranged in banks or other suitable compute units or the like. For example, the target computing device 104 may have an architecture described in U.S. Pat. No. 11,811,872, which is incorporated herein by reference. The controller 112 may include multiple cooperating controllers, for example with a main device controller which controls multiple sub-controllers, which in turn control subsets of the processing elements 116 (e.g., compute units formed of a plurality of individual processing elements 116). In other examples, the sub-controllers may be integrated with the processing elements 116 and/or with banks or other suitable sets or compute units of processing elements 116. Accordingly, as described herein, the processing elements 116 may include both control elements capable of executing instructions to effect program logic and the slave processing elements on which computations are performed at the instruction of the control elements.

The controller 112 is further in communication with memory 120, which may be separate from or integrated with the controller 112. The memory 120 may include suitable volatile or non-volatile memory, such as a random-access memory (RAM) and/or an electronic, magnetic, optical, or other type of non-volatile physical storage device. Examples of such storage devices include a non-transitory computer-readable medium such as a hard drive (HD), solid-state drive (SSD), read-only memory (ROM), electrically-erasable programmable read-only memory (EEPROM), or flash memory.

The memory 120 is configured to store instructions for execution by the controller 112. In particular, the memory 120 stores processing management instructions 124, which when executed, configure the controller 112 to manage the processing elements 116 to carry out certain functionality. For example, the processing manager 124 may generally be configured to serve as an interface between the host device 108 and the processing elements 116. That is, the processing manager 124 may include suitable libraries and/or facilities to convey instructions and/or requests or the like from the host device 108 to suitable instructions for processing by the processing elements 116. The controller 112 when so configured during execution of the processing management instructions 124, may be referred to as the processing manager 124.

The memory 120 further stores exception decoding instructions 128, which when executed, configure the controller 112 to decode exceptions generated by the processing elements 116 during execution of certain programs or functions, as will be further described herein. For example, the exception decoder 128 may be configured to decode exceptions generated by the processing elements 116, including exceptions which may be managed at the target computing device 104 and exceptions triggering a host call to the host device 108. Accordingly, the controller 112 when so configured during execution of the exception decoding instructions 128, may be referred to herein as the exception decoder 128.

The memory 120 further stores an exception log 132 configured to log exceptions representing a host call or a request to the host computing device 108 for system services, as will be further described herein.

The target computing device 104 further includes an external interface 136 which may include a serial or parallel interface, such as a universal serial bus (USB) or a peripheral component interconnect express (PCIe) interface, allowing the target computing device 104 to interface with other computing devices, such as the host computing device 108.

The host computing device 108 includes a processor 140, a non-transitory machine-readable medium, such as a memory 144, and an interface 148. The processor 140 is interconnected with the memory 144 and the interface 148 to control the operations thereof.

The processor 140 may include a central processing unit (CPU), a field-programmable gate array (FPGA), an application-specific integrated circuit (ASIC), or similar processor. The processor 140 may be one processor or more than one processor configured for collective operation. The processor 140 cooperates with the memory 144 to realize the functionality described herein.

In particular, the memory 144 may include volatile working memory, such as a random-access memory (RAM) and/or an electronic, magnetic, optical, or other type of non-volatile physical storage device. Examples of such storage devices include a non-transitory computer-readable medium such as a hard drive (HD), solid-state drive (SSD), read-only memory (ROM), electrically-erasable programmable read-only memory (EEPROM), or flash memory. Some or all of the memory 144 may be integrated with the processor 140.

The memory 144 encodes or stores computer-executable instructions thereon, which when executed by the processor 140, enable or configure the host computing device 108 to perform the functionality described herein. In particular, the memory 144 stores an operating system 152 configured to manage the hardware and software resources of the host computing device 108 and provide system services via a system kernel (not depicted). The memory 144 further stores a request handling instructions 156, which when executed, configure the processor 140 to handle requests for system services (i.e., host calls) made by the target computing device 104. Accordingly, the processor 140 when so configured during execution of the request handling instructions 156, may be referred to herein as the request handler 156. In some examples, the request handler 156 may be configured as a daemon on the host device 108, configured to run as a background process to the normal operation of the host device 108.

The external interface 148 may be a serial or parallel communications interface, such as a Universal Serial Bus (USB) interface or Peripheral Component Interconnect Express (PCI-e) interface, that allows for communications to external devices, such as the target computing device 104.

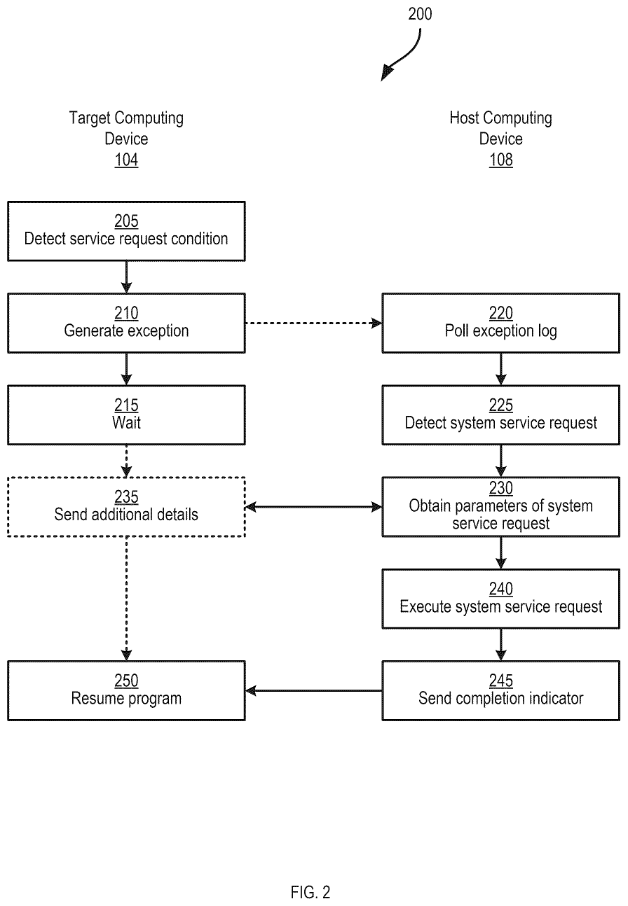

Turning now to FIG. 2, the functionality implemented by the devices 104 and 108 will be discussed in greater detail. FIG. 2 illustrates a method 200 of requesting and provisioning system services in a constrained environment. In particular, the method 200 will be discussed in conjunction with its performance in the system 100, and more particularly by the target computing device 104 operating in a constrained environment to request system services and by the host computing device 108 to handle system service requests. In other examples, the method 200 may be performed by other suitable devices or systems.

The method 200 may be initiated at the target computing device 104 at block 205. For example, the target computing device 104 may be executing a program and may detect, at block 205, a service request condition. In particular, the service request condition represents an operating condition at the target computing device 104 for which a system service is desired or requested.

For example, the program may be a program compiled and loaded from the host computing device 108 for system and/or unit testing of components of the target computing device 104, for debugging and/or testing of the program itself, or the like. Accordingly, in such testing conditions, it may be informative and helpful to issue system calls, for example to read or write certain parameters during execution of the program or the like. Thus, the service request condition may be integrated into the program executed by the target computing device 104. That is, during execution of the program by the processing elements 116, the processing elements 116 may identify the service request condition. In other examples, other service request conditions are also contemplated.

In response to detecting the system service condition at block 205, the target computing device 104 generates an exception at block 210. The exception may function as a system interrupt at the target device 104, and hence may cause the target device 104 to halt execution of the program until the exception is resolved. In particular, the exception may be generated by the one or more processing elements 116 which identified the service request condition and passed to the exception decoder 128 for handling. The processing elements 116 may generate exceptions in response to faults such as out of order packets, corrupted packets, credit overflow, packet overflow or the like, or software-based conditions, including service request conditions, signal completion, other software faults, or the like. That is, the processing elements 116 may generate exceptions representing service request conditions, as well as other exception conditions. Both types of exceptions may be passed to the exception decoder 128 for decoding.

The exception decoder 128 may be therefore configured to handle any exceptions generated by the processing elements. In particular, the exception decoder 128 may analyze the exception to determine whether the target device 104 is capable of handling the exception locally, or whether the exception represents a request for a system service from the host device 108. That is, the exception decoder 128 may handle all types of exceptions generated during execution of a program at the target computing device 104. If the exception decoder 128 determines that the target device 104 is capable of handling the exception locally, the exception decoder 128 may cooperate with the controller 112 or other suitable components of the target device 104 to handle the exception.

If the exception decoder 128 determines that the exception relates to a system service request, the exception decoder 128 may write the exception to the exception log 132. In particular, the exception decoder 128 may identify, in the exception log 132, the particular processing element 116 and/or compute unit which generated the exception. In some examples, the exception log 132 may simply identify the processing element and/or compute unit identifier and/or other sufficient information to identify the source of the exception. That is, the exception log 132 may serve as a reference of the source of the exception (e.g., to identify the compute unit by processing elements 116, by bank of processing elements 116 or the like) to allow the host device 108 to refer directly to the source of the exception for parameters of the system service request, as described in further detail below. In other examples, the exception log 132 may store additional parameters of the exception, such as the type of system service requested (e.g., read requests, write requests, log requests, etc.), data for the system service requested (e.g., data to be read/written, file names, etc.), and the like.

In some examples, in addition to writing the exception to the exception log 132, the exception decoder 128 may additionally initiate a system interrupt at the host device 108 to indicate to the host device 108 that an exception including a host call or a request for system services has been logged to the exception log 132.

The target computing device 104 may then wait, at block 215, for the exception to be resolved prior to continuing with execution of the program.

The method 200 may be initiated at the host computing device 108 at block 220. At block 220, the host computing device 108, and in particular, the request handler 156, detects a polling condition to poll the target device 104, and in particular, the exception log 132 of the target device 104, for system service requests. In some examples, the polling condition may include detection of a system interrupt sent to the host device 108 by the target device 104. In other examples, the polling condition may be passage of a predetermined period of time, such that the host device 108 is configured to periodically poll the target device 104 for system service requests. For example, in response to a system interrupt sent to the host device 108 by the target device 104, the host device 108 may poll the exception log 132 periodically until the system service requests are resolved and the exception log 132 is empty.

At block 225, the host computing device 108 detects, in response to a polling action at block 220, a system service request in the exception log 132. In particular, the host computing device 108 may extract at least the source of the exception from the exception log 132.

At block 230, the host device 108 is configured to obtain the parameters of the system service request. For example, if the exception log 132 includes the parameters of the system service request, then the host device 108 may simply read the parameters of the system service request from the exception log 132. In other examples, the host device 108 may be configured to request the parameters of the system service request from the target device 104, and in particular, from the compute unit identified in the exception log 132 as being the source of the exception. In particular, to interface with the processing elements 116 forming the identified compute unit, the request handler 156 may interface with the processing manager 124 to facilitate communications to and from the processing elements 116, and in particular, retrieval of the parameters for the system service request.

Thus, optionally at block 235, the target device 104, and in particular, the processing manager 124, may receive the request for system service parameters from the host device 108. The processing manager 124 may additionally process the request to obtain the system service parameters from the identified compute unit and send the system service parameters back to the host device 108. In particular, the processing manager 124 may interface with the compute unit and/or processing elements 116 to obtain the system service parameters from the compute units and relay the system service parameters to the host computing device 108. For example, the system service parameters may include an identification of the type of system service requested, data for the system service (e.g., read data, write data, file names, etc.), and the like. The target device 104 may then continue to wait for the exception to be resolved.

At block 240, after obtaining the parameters of the system service request, the host device 108 is configured to execute the system service request according to the obtained parameters. In particular, the host device 108 may invoke the operating system 152 to execute the system service request. For example, the host device 108 may perform one or more read or write operations, obtain files, log files, or similar. The host device 108 may further be configured to clear the exception pertaining to the executed system service request from the exception log 132 at the target device 104.

At block 245, upon completion of the system service request, the host device 108, and in particular, the request handler 156, is configured to send a completion indicator to the target device 104. The completion indicator may simply be a flag indication completion of the system service request, or the completion indicator may include the results of the system service request. For example, if the system service request is a read request, the completion indicator may include the read data from the read request.

At block 250, the target device 104, and in particular, the program manager 124, may receive the completion indicator from the host device 108. The program manager 124 may relay the results and/or the completion indicator to the compute unit from which the exception originated. For example, the program manager 124 may relay the read data from a read request to the identified compute unit. In some examples, rather than modification of the exception log 132 at block 240 by the host device 108, the target device 104, and in particular, the program manager 124, may be configured to clear the exception pertaining to the executed system service request from the exception log 132. In response to receiving the completion indicator, the compute unit may resume the program.

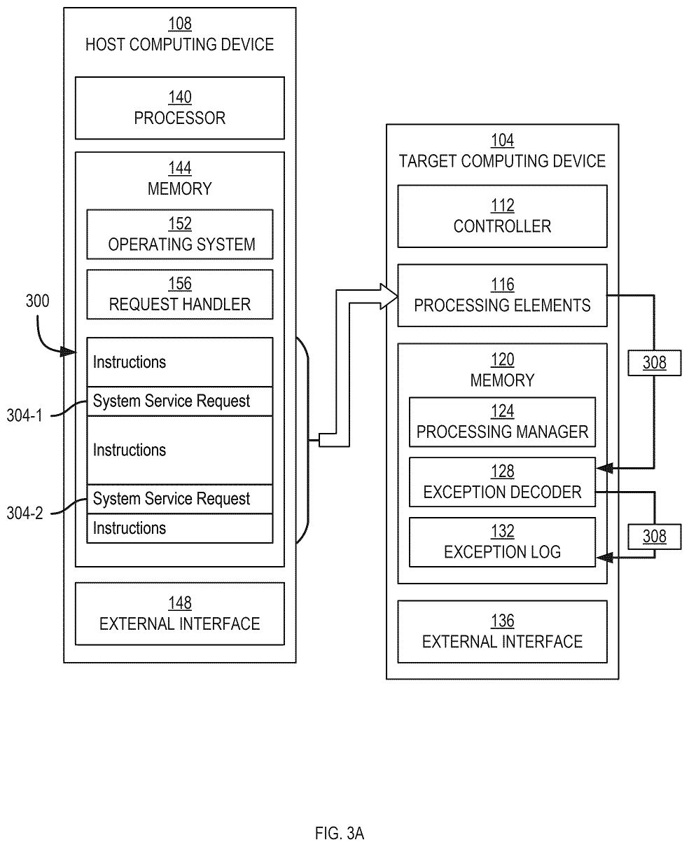

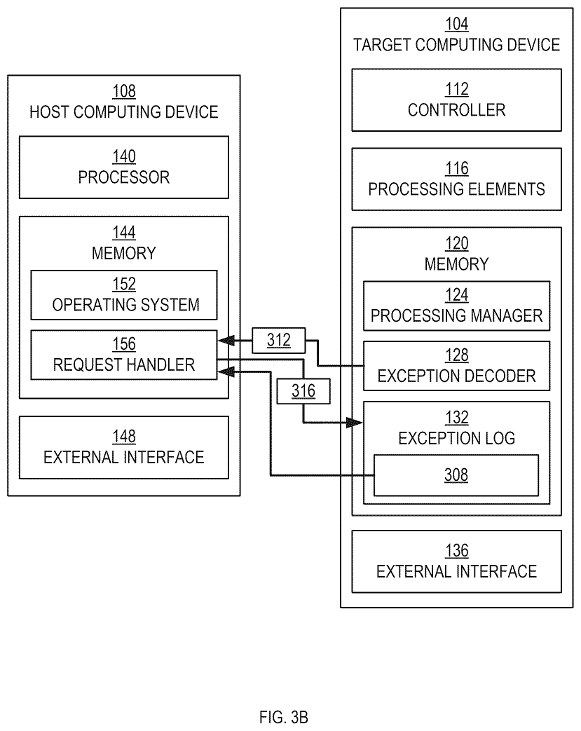

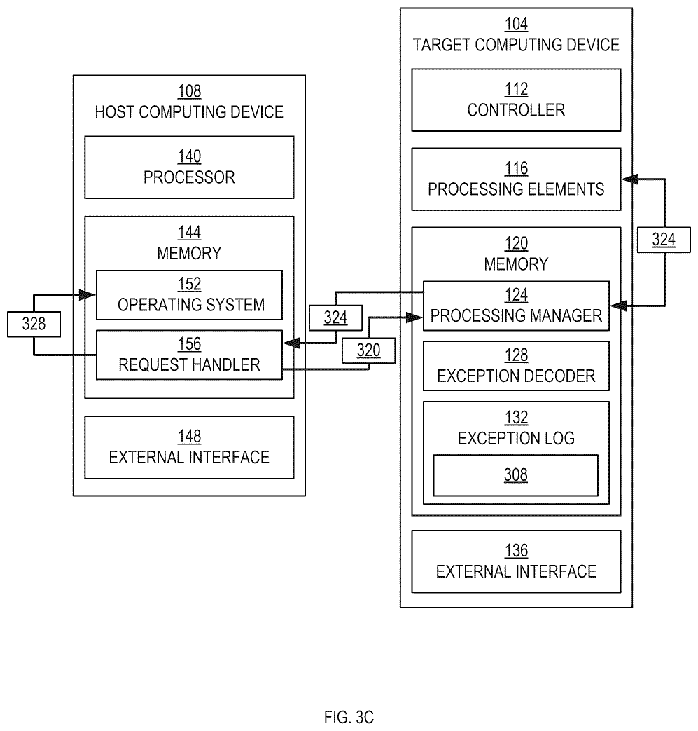

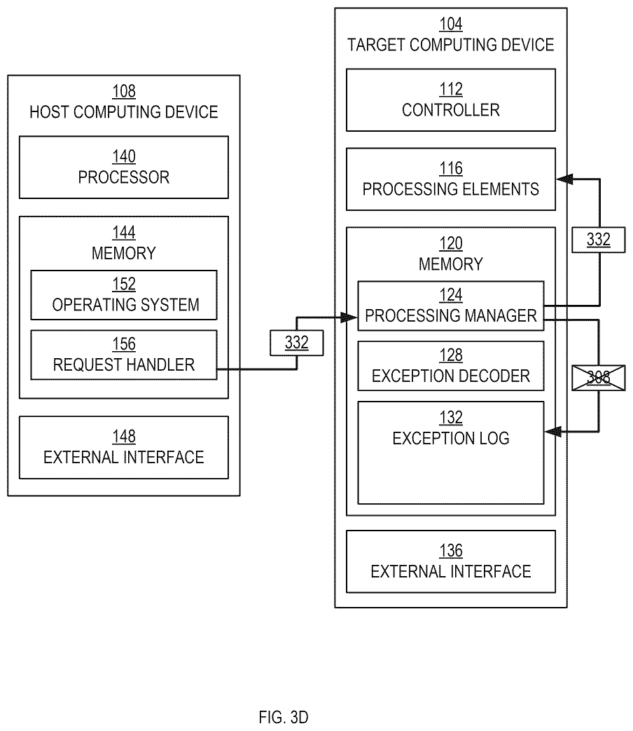

The presently described system and method may be particularly employed for performing unit testing, for example of components of the target device 104, and/or for testing new programs or software or portions thereof. In particular, referring to FIG. 3A, a testing program 300 may be stored on the host computing device 108. The testing program 300 may include one or more system service requests, of which two example system service requests, 304-1 and 304-2 are depicted, interspersed with the remainder of the instructions forming the program 300. For example, the system service request 304-1 may be a read requests to obtain information to facilitate and/or enable further execution of the instructions in the testing program 300, while the system service request 304-2 may be a write request to log or track the results of the execution of the instructions to facilitate debugging and/or tracking of intermediate instructions within the testing program 300.

In particular, the testing program 300 may be configured and compiled to be executed on the target device 104 and may be loaded onto the target device 104 for execution by a runtime executor (not shown) of the host computing device 108. Upon receipt of the testing program 300, the target device 104 may deploy the testing program 300 for execution by the processing elements 116 (or a subset thereof).

During execution of the testing program 300, upon encountering the first system service request 304-1, the processing elements 116 and/or compute unit assigned to execute the testing program 300 may detect a service request condition (i.e., at block 205 of the method 200). Accordingly, the processing elements 116 may generate an exception 308 and send the exception 308 to the exception decoder 128. In particular, the exception 308 may include an indication of the processing element 116 from which the exception 308 was generated, and an indication that the exception pertains to a system service request, namely the system service request 304-1. The processing elements 116 may further pause execution of the testing program 300 until the exception 308 is resolved. The exception decoder 128, in turn, may identify that since the exception 308 is generated as a result of the system service request 304-1, the target device 104 is not capable of handling the exception 308, and hence may write the exception 308 to the exception log 132.

Referring to FIG. 3B, the exception decoder 128 may additionally send a system interrupt 312 to the host device 108. In particular, the system interrupt 312 may initialize the request handler 156 configured as a daemon in the host device 108. In response to the system interrupt 312, the request handler 156 sends a poll 316 to the exception log 132 to obtain the exception 308 and the details thereof from the exception log 132. In particular, the exception 308 may identify the processing element(s) 116 from which the exception 308 originated.

Referring to FIG. 3C, the request handler 156 may optionally send a request 320 to the target device 104 to identify system service parameters of the requested system service. In particular, the request 320 may similar identify the source processing elements 116 of the exception 308 to allow the processing manager 124 to cooperate with the identified processing elements 116 to identify system service parameters 324. For example, in the example of the system service request 304-1 being a read request, the system service parameters 324 may indicate the fact of the read request and a target address of the data to be read. The processing manager 124 may act as an interface between the request handler 156 and the processing elements 116, and may therefore be configured to return the system service parameters 324 to the request handler 156.

Upon receiving the system service parameters 324, the request handler 156 may be configured to request or initiate performance of the system service 328 by the operating system 152. For example, the request handler 156 may invoke the operating system 152 to read data from the target address identified in the system service parameters 324.

Referring now to FIG. 3D, upon completion of the system service 328 by the operating system 152, the request handler 156 may send a completion indicator 332 to the target computing device 104, and more particularly, to the processing manager 124. The completion indicator 332 may include the read data as obtained from execution of the system service 328. The processing manager 124 may forward the completion indicator 332 to the processing elements 116 to enable to the processing elements 116 to act on the read data as appropriate. Alternately, the processing manager 124 may simply forward the completion indicator 332 to the processing elements 116 to allow the processing elements 116 to carry on with execution of the program 300. Accordingly, the processing elements 116 may continue executing the program 300, for example until the second system service request 304-2 is encountered, thereby initiating another iteration of the method 200.

In some examples, the processing manager 124 may further update the exception log 132 to clear the exception 308, for example by marking the exception 308 as complete, by removing the line item representing the exception 308 entirely, or the like.

Accordingly, as described herein, the system provides a mechanism by which a target computing device, normally having no or limited system service capabilities, to leverage the system service capabilities of a host computing device in the environment in which the target computing device is operating. In particular, the target computing device may generate exceptions stored in an exception log, which is polled by the host computing device. The exceptions may function as system interrupts in both the target computing device (i.e., in which a program being executed is paused until the exception is resolved) and the host computing device (i.e., in which a request handler, which may be a daemon running as a background process in the host computing device, is initialized to handle the exception). The host computing device may then execute the system service requests indicated in the exception log, including requesting additional information such as parameters of the system service requested from the target computing device as necessary. Upon completion of the system service requested, the target computing device may resume execution of the program from which the system service request originated.

The scope of the claims should not be limited by the embodiments set forth in the above examples but should be given the broadest interpretation consistent with the description as a whole.

1. A host computing device comprising:
a memory and a communications interface;
a processor interconnected with the memory and the communications interface, the processor configured to:
detect a request, by a target computing device, for execution of a system service by the host computing device;
obtain system service parameters for the requested system service;
execute the system service in accordance with the system service parameters; and
send a completion indicator to the target computing device.

2. The device of claim 1, wherein to detect the request for execution of the system service, the processor is configured to:
detect a polling condition and in response to the polling condition, poll an exception log of the target computing device; and
identify the request represented by an exception detected in the exception log.

3. The device of claim 2, wherein the polling condition comprises one of: a system interrupt initiated at the host computing device by the target computing device; and passage of a predetermined period of time.

4. The device of claim 1, wherein to obtain the system service parameters, the processor is configured to request the system service parameters from the target computing device.

5. The device of claim 1, wherein the system service comprises one or more of: a read request, a write request, and a log request.

6. A target computing device comprising:
a plurality of processing elements configured to execute a program;
a memory and a communications interface;
a controller interconnected with the memory, the communications interface, and the plurality of processing elements, the controller configured to:
during execution of the program by at least one of the processing elements, detect a service request condition for requesting a system service from a host device;
in response to the service request condition, generate an exception to request the system service from the host device; and
in response to a completion indicator indicating completion of the requested system service from the host device, resume execution of the program.

7. The device of claim 6, wherein the controller is configured to log the exception in an exception log at the target device.

8. The device of claim 7, wherein to generate the exception, the controller is configured to initiate a system interrupt at the host device to cause the host device to poll the exception log to identify the exception as the request for the system service.

9. The device of claim 6, wherein the controller is further configured to:
receive a request for system service parameters from the host device; and
send, to the host device, the system service parameters for the host device to execute the system service.

10. The device of claim 6, wherein the system service comprises one or more of: a read request, a write request and a log request.

11. A method comprising:
detecting, at a host device, a request for a system service at a target device;
obtaining system service parameters for processing the request from the target device;
executing the system service request in accordance with the system service parameters; and
sending a completion indicator to the target device.

12. The method of claim 11, wherein detecting the request for the system service comprises: polling an exception log at the target device to identify an exception indicating the request for the system service.

13. The method of claim 12, further comprising: detecting a system interrupt initiated by the exception, wherein the polling is performed in response to the system interrupt.

14. The method of claim 11, wherein obtaining the system service parameters comprises requesting the system service parameters from the target device.

15. The method of claim 11, wherein the system service comprises one or more of: a read request, a write request, and a log request.

16. A method comprising:
during execution of a program at a target device, detecting a service request condition for requesting a system service from a host device;
in response to the service request condition, generating an exception to request the system service from the host device; and
in response to a completion indicator from the host device, resuming the execution of the program.

17. The method of claim 16, further comprising: logging the exception in an exception log stored at the target device.

18. The method of claim 17, wherein generating the exception comprises: initiating a system interrupt at the host device to cause the host device to poll the exception log to identify the exception as the request for the system service.

19. The method of claim 16, further comprising:
receiving a request for system service parameters from the host device; and
sending, to the host device, the system service parameters for the host device to execute the system service.

20. The method of claim 16, wherein the system service comprises one or more of: a read request, a write request and a log request.
